(19) United States
(12) Patent Application Publication
(10) Pub. No.: US 2018/0218361 A1
(43) Pub. Date: Aug. 2, 2018

(54) MANAGEMENT SYSTEM AND APPLICATION

(71) Applicant: Serkan BAKIRTAS, Istanbul (TR)

(72) Inventor: Serkan BAKIRTAS, Istanbul (TR)

(73) Assignee: Serkan BAKIRTAS, Istanbul (TR)

(21) Appl. No.: 15/746,849

(22) PCT Filed: Apr. 11, 2016
(86) PCT No.: PCT/TR2016/000044

§ 371 Date: Jan. 23, 2018

(30) Foreign Application Priority Data
Jul. 23, 2015 (TR) 2015/09138

(51) Int. Cl. G06Q 20/36; G06Q 20/28

(52) U.S. Cl. CPC G06Q 20/36; G06Q 20/28

(57) ABSTRACT

The present invention is related to a kind of smart management system and its application that enables the use of all centers and stations service points providing car cleaning, washing, hygiene, maintenance, protection, tire change services and car parking.

### TECHNICAL FIELD

The present invention is related to a kind of smart management system and its application that enables the use of all centers and stations service points providing car cleaning, washing, hygiene, maintenance, protection, tire change services and car parking.

### STATE OF THE ART

From the day human beings existed on earth until today, they have been in a constant development process to meet their needs. Today, this development process in our globalized world, with the support of technology and the increase in human population, is enabling mankind to live more efficiently by using time and offering alternative solutions.

The most important factor for today's life is using time right. In order to use time in the right way, people need to do their daily jobs fast. In order to provide this, people try to do many things using their cars and try to gain more time by providing their transportation by cars. However, the most time consuming things are the troubles related to their cars and periodic cleaning, washing, hygiene, maintenance, protection, and tire change services. Also, for refueling the cars, they need to visit fuel stations.

The consumed time mentioned above related to car services removes the desired time-saving by using the cars and this stands out as an unwanted situation. Because people perform the payments related to car cleaning, washing, hygiene, maintenance, tire change services and car parking separately and as there is no quick pay option, generally cash queues occur.

In addition, companies providing cars for their employees in fleets have to keep separate records for each car and separate billing transactions for each operation, accounting procedures take too much time and mistakes occur. Also, employees have to provide invoices for every transaction and this makes controllability difficult.

At the same time, since there is no front cash system for the above-mentioned services, keeping cash money is required and mostly the user is stuck in a difficult situation.

Today, the companies providing their employees food allowances keep the related records more easily since they meet the front payments and this shows that a front paid system related to car services individually or for companies is required.

### DEFINITION OF THE INVENTION

The present invention removes the disadvantages mentioned in the state of the art.

The present invention is related to a kind of smart management system and its application that enables the use of all centers and stations service points providing car cleaning, washing, hygiene, maintenance, protection, tire change services and car parking.

By using the inventive smart management system, unrecorded transactions are avoided, hence budget control is facilitated. Due to the front payment system of the present invention, the payment transactions are completed in a very short time, thus time saving is provided.

As the service is billed in the present invention, a single invoice accounting-related convenience and managerial control are provided. Thus, fleet management of establishments are facilitated and the details of the services provided, such as the place and time, can be controlled due to the detailed reporting of the smart management system.

Due to the mobile application of the inventive smart management system, both corporate and individual users get their services by being directed to the nearest application and service points. Thus, for city life and in unknown places, unnecessary time consumption is avoided.

Since the present invention is a pre-paid system, it removes the cash requirement. The users are free to keep cash money.

### DISCLOSURE OF THE INVENTION

The present invention is a kind of smart management system and its application, wherein it provides the use of services at the service points/stations and centers where the smart management system has been installed by using the system application (a mobile application or key chain) without the customers paying any cash. The users can make use of the periodic campaigns with economic prices.

This invention is a kind of smart management system and its application, wherein its functioning is as follows:
Corporate or individual users apply for registration of membership from the website of the system,
Each member has a specially formed keychain or mobile application key code,
The members execute purchasing transactions (pre-payment) of the member station services (car cleaning, washing, maintenance, protection, tire change service, car parking, etc.) by using the Internet,
They can view the service points and use the purchased services from the nearest place without using cash.

In the present invention, since only single billing is performed for all the purchased operations, many transactions can be executed with a single accounting operation.

1. The present invention is a kind of smart management system and its application wherein its characteristic is to be comprised of the following functioning steps:
Corporate or individual users apply for registration of membership from the website of the system,
Each member has a specially formed keychain or mobile application key code,
The members execute purchasing transactions (pre-payment) of the member station services (car cleaning, washing, maintenance, protection, tire change service, car parking, etc.) by using the Internet,
They can view the service points and spend the purchased services from the nearest place without using cash but by using the system keychain or mobile application key code.
